(19) United States
(12) Patent Application Publication
(10) Pub. No.: US 2012/0250332 A1
(43) Pub. Date: Oct. 4, 2012

(54) FRAMING SHUTTER SYSTEM FOR A LUMINAIRE

(75) Inventors: Pavel JURIK, Prostredni Becva (CZ); Josef Valchar, Prostredni Becva (CZ)

(73) Assignee: ROBE LIGHTING S.R.O.

(21) Appl. No.: 13/363,330

(22) Filed: Jan. 31, 2012

Related U.S. Application Data
(60) Provisional application No. 61/438,167, filed on Jan. 31, 2011.

(51) Int. Cl. F21V 11/04

(52) U.S. Cl. 362/321

(57) ABSTRACT

Described are an improved automated luminaire 12 and luminaire systems 10 employing an improved automated framing shutter mechanism 25 for an automated luminaire which provides the user with more than two selectable edge shapes for each shutter blade which can be both independently translated and rotated relative to the light beam and collectively rotated around the central axis of the light beam of the automated luminaire.

### RELATED APPLICATION

This application claims priority of Provisional Patent Application 61/438,167 filed 31 Jan. 2011.

### TECHNICAL FIELD OF THE INVENTION

The present invention generally relates to an automated framing shutter system, specifically to a framing shutter system for use within an automated luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

The optical systems of such luminaires may include a gate or aperture through which the light is constrained to pass. Mounted in or near this gate may be devices such as gobos, patterns, irises, color filters or other beam modifying devices as known in the art. The use of a framing shutter system at this point allows control over the size and shape of the output beam and thus the size and shape of the image projected onto a surface.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

FIG. 2 illustrates an automated luminaire 12 incorporating the improved shutter system 25. A light emitting lamp 21 contains a light source 22 which receives power from power supply 27. The light is reflected and controlled by reflector 20 through an aperture or imaging gate 24 and then through a framing shutter system 25. The resultant light beam may be further constrained, shaped, colored and filtered by optical devices 26 which may include dichroic color filters, gobos, rotating gobos, variable aperture iris, effects glass and other optical devices well known in the art. The final output beam may be transmitted through output lenses 28 and 31 which may form a zoom lens system.

Framing shutter system 25 is most commonly constructed as a plurality of metal plates or blades that may be individually and separately inserted across the light beam to mask a portion of that beam. Each blade may be completely removed from the light beam or may be adjusted to occlude a portion of the light beam. It is possible to use any number of blades; however it is common to utilize four allowing framing the projected image to common rectangular shapes such as picture frames. It is also well known to provide individual angular control for each blade such that the four blades do not have to remain at fixed, perpendicular, angle to each other and thus irregular trapezoidal or triangular shapes may be formed by combinations of the blades.

The prior art contains various examples of such framing shutter systems, for example U.S. Pat. No. 1,793,945 illustrates a four blade system where each blade may be manually adjusted to cover a portion of the light beam. This system does not provide beam rotation. U.S. Pat. No. 4,890,208 to Izenour discloses a further four blade system where each blade is provided with two motors such that both the position and angle of each blade can be remotely adjusted. U.S. Patent Application 2005/02319578 to Wynne-Willson discloses a yet further system where each blade can be remotely adjusted for position and rotation and may also be rotated around the beam. Wynne-Willson further discloses that each blade may have two selectable edges which may be optionally inserted across the beam. He illustrates this as a straight edge or a curved edge. This offers some advantage to the user as shapes other than straight sided polygons can be framed, however the system disclosed is limited to two edge shapes, and is a very complex mechanism which would be expensive and difficult to manufacture. Further mechanisms are disclosed in U.S. Pat. No. 6,550,939, U.S. Pat. No. 6,744,693, U.S. Pat. No. 6,939,026, patent application WO 03/023513, patent application WO 96/36384 and UK Patent GB2270969. All of these offer some means for framing at least two sides of a light beam and may also provide position and rotation of each blade however none of them provides the selection of more than two different edges of a blade.

There is a need for an improved automated framing shutter mechanism for an automated luminaire which provides the user with more than two selectable edge shapes for each blade and is simple to manufacture.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates an automated luminaire with a framing shutter system;

FIG. 3 illustrates an embodiment of the framing shutter system;

FIG. 4 illustrates the framing shutters of the embodiment of the invention illustrated in FIG. 3;

FIGS. 5, 6, and 7 illustrate linear movement operation of a single shutter blade of the embodiment of the invention illustrated in FIG. 3;

FIGS. 8, 9 and 10 illustrate leading edge selection operation of a single blade of the embodiment of the invention illustrated in FIG. 3;

FIGS. 11, 12 and 13 illustrate different effective operational ranges of linear movement of a single blade of the embodiment of the invention illustrated in FIG. 3;

FIGS. 14, 15 and 16 illustrate rotational movement operation of a single shutter blade of the embodiment of the invention illustrated in FIG. 3;

FIG. 17 illustrates a side view of an embodiment of the four blade system of FIG. 3 where each blade operates in its own plane;

FIG. 18 illustrates a side view of an embodiment of the four blade system of FIG. 3 where two blades operate in their own planes and two blades share a plane of operation; and

FIG. 19 illustrates a side view of an embodiment of the four blade system of FIG. 3 where two blades share one plane of operation and the other two blades share another plane of operation.

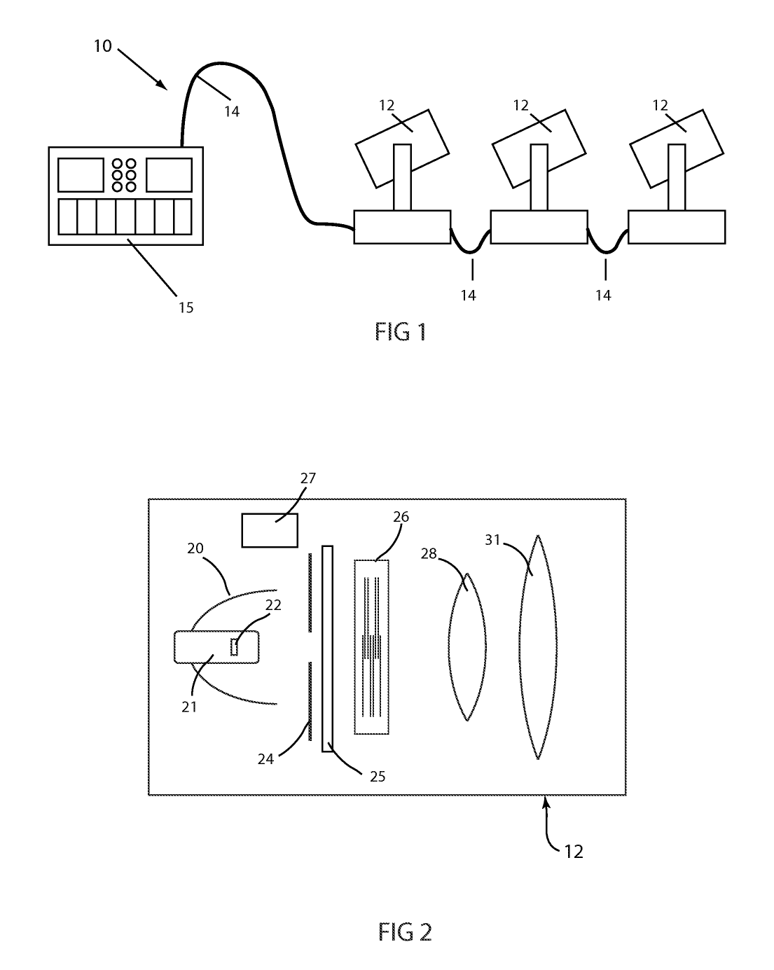

### DETAILED DESCRIPTION OF THE INVENTION

Preferred embodiments of the present invention are illustrated in the FIGURES, like numerals being used to refer to like and corresponding parts of the various drawings.

The present invention generally relates to an automated luminaire, specifically to the configuration of an improved automated framing shutter mechanism within such a luminaire which provides the user with more than two selectable edge shapes for each shutter blade.

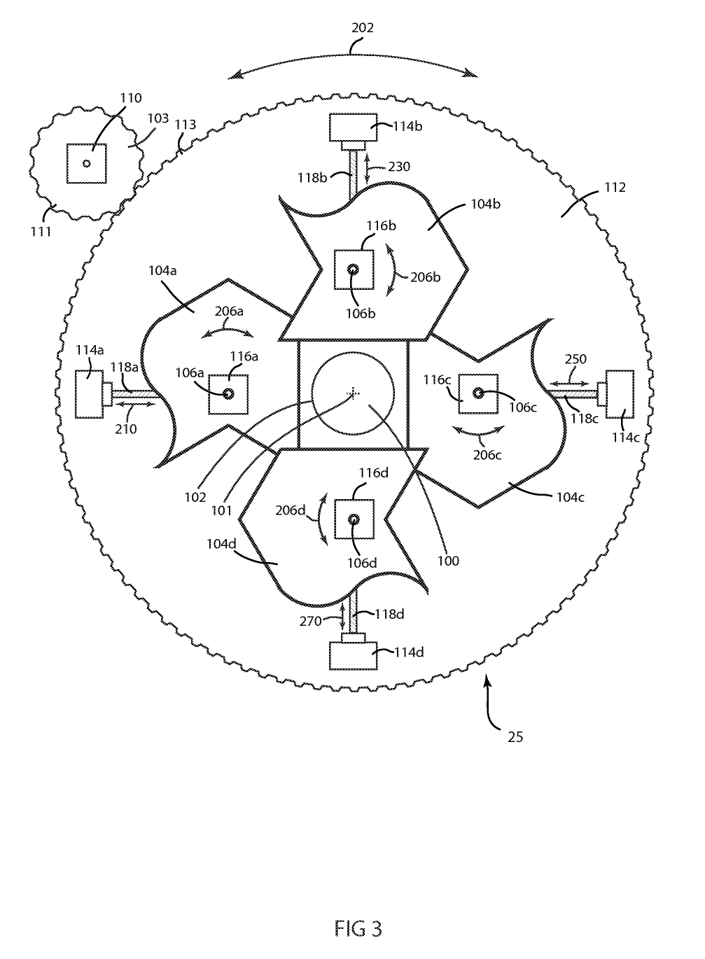

FIG. 3 illustrates in greater detail an embodiment of the framing shutter 25 from the automated luminaire 12 illustrated in FIG. 2. Central aperture 102 provides the main light path for the optical system of the luminaire for a constrained light beam 100 with a central axis 101. The aperture 102 and framing shutter system 25 are positioned at a point in the optical train such that the output optics may provide a hard edge focus of the shutter blades in the output beam. Blades 104a, 104b, 104c and 104d are framing shutter blades. With the mechanism in the state as illustrated in FIG. 3 where the shutter blades 104a, 104b, 104c and 104d are outside of the central aperture causing no occlusion of the light beam 100 allowing the light beam will pass through the framing shutter system 25 unchanged.

Each of the blades 104a, 104b, 104c and 104d may be separately and independently moved towards or away the central aperture 102 in directions indicated by arrows 210, 230, 250 and 270 respectively through the respective operation of motors 114a, 104b, 104c and 104d driving lead screws 118a, 118b, 118c and 118d. Although a lead screw system is herein illustrated for moving the blade(s), the invention is not so limited and other means for moving the blade(s) may be utilized. In further embodiments the blade movement may be effected through cams, gears, sliders, linear actuators, linkages or other mechanisms well known in the art to provide linear motion, without detracting from the invention. Each of the blades 104a, 104b, 104c and 104d may further be separately and independently rotated respectively in directions indicated by arrows 206a, 206b, 206c and 206d about respective central rotational axes 106a, 106b, 106c and 106d by respective motors 116a, 116b, 116c and 116d.

In the embodiment shown in FIG. 3, Blades 104a, 104b, 104c and 104d and their associated motor and drive systems may be mounted on carrier or backing plate 112. Backing plate 112 and the framing shutter system complete with blades and motors may further be rotated in its entirety about axis 101 by a gear 111 driven by a motor 110. In the embodiment shown the backing plate 112 has teeth 113 which mesh with the gear teeth of the drive gear 111. Although a gear system is illustrated for the rotation of backing plate 112 the invention is not so limited and any system for rotating backing plate 112 may be utilized. In other embodiments the backing plate rotation may be effected through direct drive, belt drives, friction drives, or other mechanisms well known in the art. In the illustrated embodiment of the invention, motors 110, 114a, 114b, 114c and 114d and 116a, 116b, 116c and 116d are stepper motors. In other embodiments other motors may be employed.

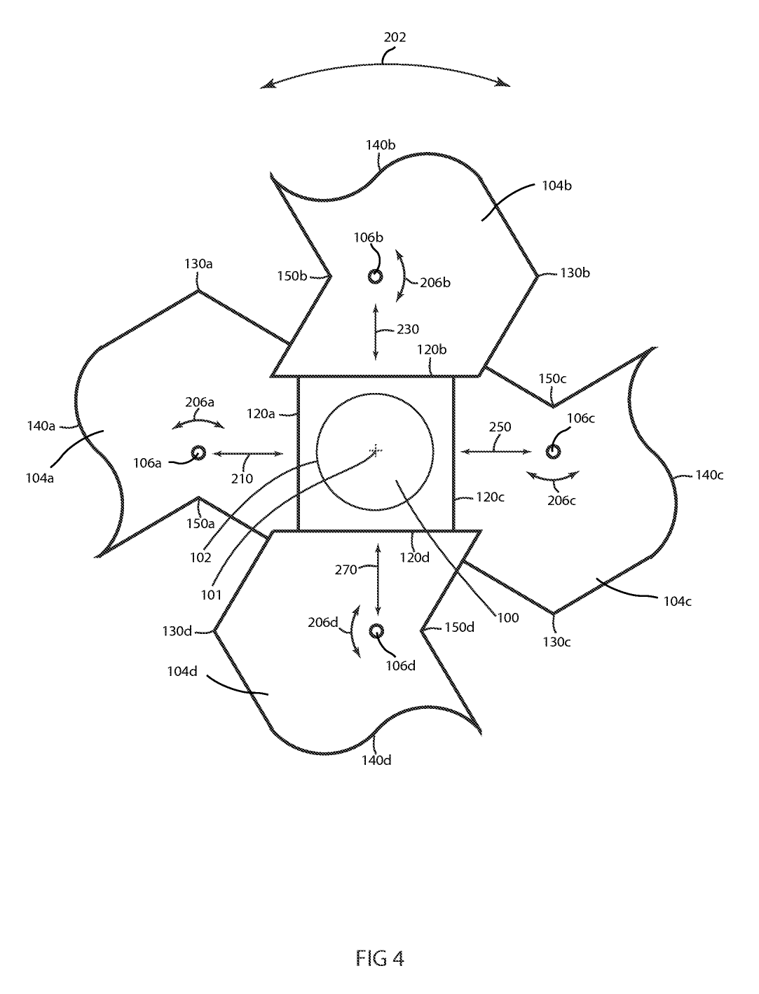

FIG. 4 provides a simplified illustration of the framing system 25 embodiment of the invention illustrated in FIG. 3. Blades 104a, 104b, 104c and 104d surround central aperture 102. Each blade 104a, 104b, 104c and 104d has a central pivot point 106a, 106b, 106c and 106d. In the position illustrated the blades 104a, 104b, 104c and 104d are positioned outside of central aperture 102 and so do not occlude the light beam.

The degrees of freedom of movement of the shutters blade 104a are illustrated by arrows 206a, 210, and 202. The degrees of freedom of movement of the shutters blade 104b are illustrated by arrows 206b, 230, and 202. The degrees of freedom of movement of the shutters blade 104c are illustrated by arrows 206c, 250, and 202. The degrees of freedom of movement of the shutters blade 104d are illustrated by arrows 206d, 270, and 202. Arrow 202 illustrates a rotational degree of freedom of all of the shutter blades 104a, 104b, 104c and 104d about the central axis 101 of the light beam 100. Arrows 210, 230, 250 and 270 illustrated the respective linear degree of freedom of shutter blades 104a, 104b, 104c and 104d. Arrows 206a, 206b, 206c and 206d illustrated the respective rotational degrees of freedom of shutter blades 104a, 104b, 104c and 104d about respective rotational axes (plural of axis) 106a, 106b, 106c and 106d.

In the embodiment illustrated in FIG. 4, each of the shutter blades have four selectable edges: 104a has 120a, 130a, 140a and 150a; 104b has 120b, 130b, 140b and 150b; 104c has 120c, 130c, 140c and 150c; and 104d has 120d, 130d, 140d and 150d;

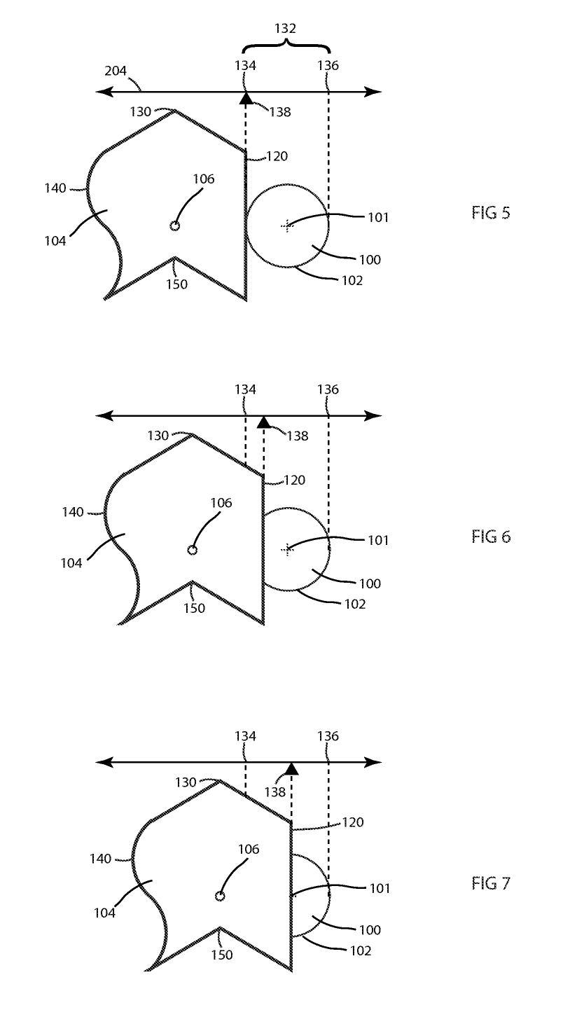

For simplicity FIG. 5 through FIG. 10 and FIGS. 14 through FIG. 19 illustrate an operation of a single blade 104 of an embodiment of the invention. The other blades of the framing shutter may be controlled in an independent but similar manner to the one illustrated in the figures illustrating a single blade. FIG. 5, FIG. 6 and FIG. 7 illustrate the progression of a shutter blade 104 into the light beam 100. Blade 104 has central pivot point 106 and first edge 120 and has a first linear freedom of movement in the direction indicated by arrow 204, towards and away from the central axis 101 of the light beam 100. In FIG. 5 blade 104 is positioned outside of central aperture 102 and does not occlude the light beam 100. In FIG. 6 blade 104 has been moved in the direction of arrow 204 toward the central axis 101 of the light beam 100 such that it now partially covers central aperture 102 space and thus partially occludes the light beam 100 with edge 120. In FIG. 7 blade 104 has been further moved in the direction of arrow 105 204 toward the central axis 101 of the light beam 100 such that it now covers approximately 50% of central aperture 102 space with edge 108 and thus increases its occlusion of the light beam. In the embodiment illustrated, Blade 104 may further be moved so as to completely cover central aperture 102 and may be freely moved to any intermediate position. In other embodiments this may not be allowed for all or some of the shutter blades.

The range of motion of linear motion along direction 204 for the shutter blade 104 when in the light beam 100 is illustrated as 132 between markers 134 and 136 the position of the blade within this range of motion is illustrated on direction 204 as 138. These markers and ranges are not constant and depend on a number of factors as will be further discussed below.

Furthermore, in the embodiment of the luminaire illustrated in the figures, the operator may set the optical system to provide a hard or soft focus on shutter blade edges (such as edge 120) and thus produce hard or soft edges to the light beam.

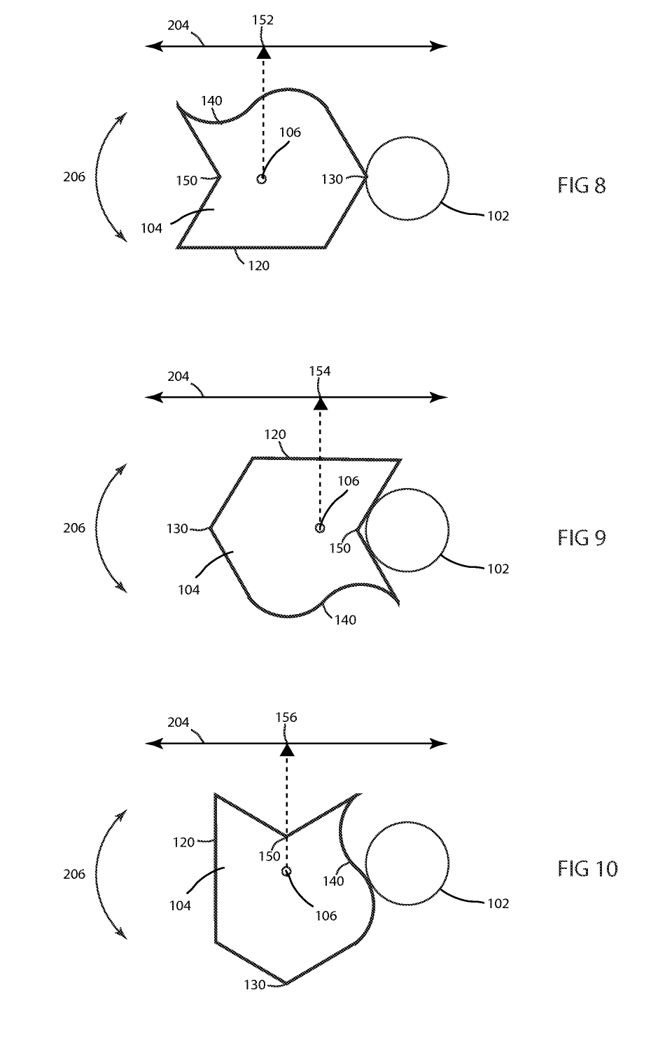

FIG. 8, FIG. 9 and FIG. 10 illustrate a yet further operation of a single blade of an embodiment of the invention. The other blades of the framing shutter may behave in an independent but similar manner. In FIG. 8 blade 104 has been rotated 90° clockwise from the position shown in FIG. 5 such that edge 130 of blade 104 is now selected as the leading edge to enter the path of the light beam 100. This edge has a distinguishably different shape to first edge 120 and, in the embodiment illustrated, forms a convex angle. In FIG. 9 blade 104 has been rotated ninety degrees (90°) counter-clockwise from the position shown in FIG. 5 such that a third edge 150 of blade 104 is now selected as the leading edge to enter the path of the light beam 100. Third edge 150 has a distinguishably different shape to first and second edges 120 and 130 respectively, and, in the embodiment illustrated, forms a concave angle. In FIG. 10 blade 104 has been rotated through 180° from the position shown in FIG. 5 such that fourth edge 140 of blade 104 is now selected as the leading edge to enter the path of the light beam 100. Fourth edge 140 may be a different shape to first edge 120, second edge 1130 and third edge 150 and, in the embodiment illustrated, forms a complex curve edge.

Note that the leading edge in FIGS. 5, FIG. 8, FIG. 9, and FIGS. 10 (120, 130, 150 and 140 respectively) are all illustrated in a position at the aperture 102 of the light beam 100 without entering the beam 100. Note also that the central axis 106 of the shutter blade 104 is not in the same position 150, 152, 154, 156 along the linear degree of freedom illustrated by arrow 204 for a normal selection of all of the leading edges 120, 130, 150 and 140 respectively.

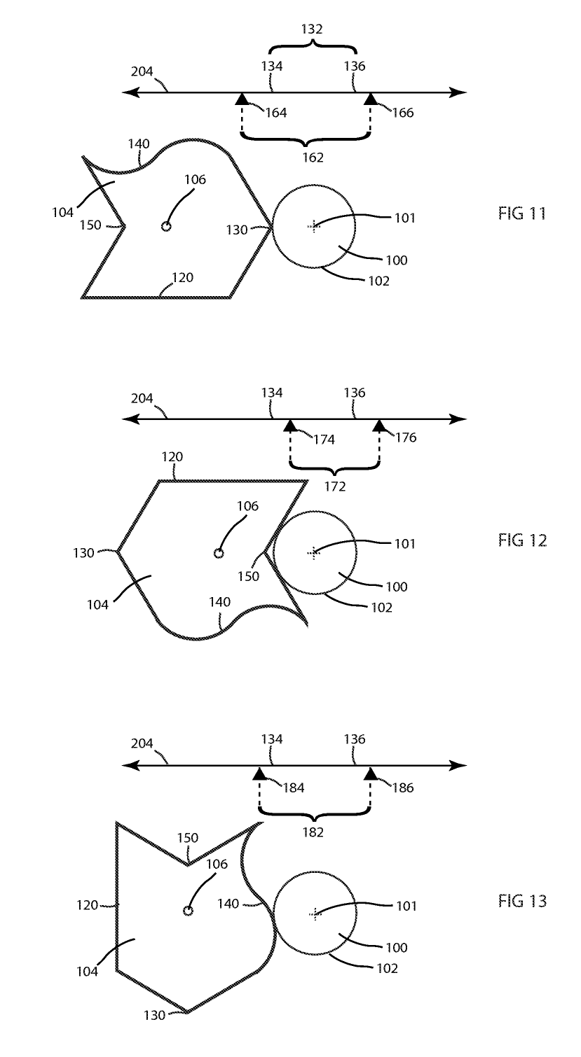

FIG. 11, FIG. 12 and FIG. 13 illustrates that the range of motion are not the same for a normal selection of a leading edge. FIG. 11 illustrates the range of motion 162, and markers 164 and 166 for leading edge 130 in comparison to the range of motion 132 and markers 134 and 136 for leading edge 120. FIG. 12 illustrates the range of motion 172, and markers 174 and 176 for leading edge 150 in comparison to the range of motion 132 and markers 134 and 136 for leading edge 120. FIG. 13 illustrates the range of motion 182, and markers 184 and 186 for leading edge 140 in comparison to the range of motion 132 and markers 134 and 136 for leading edge 120.

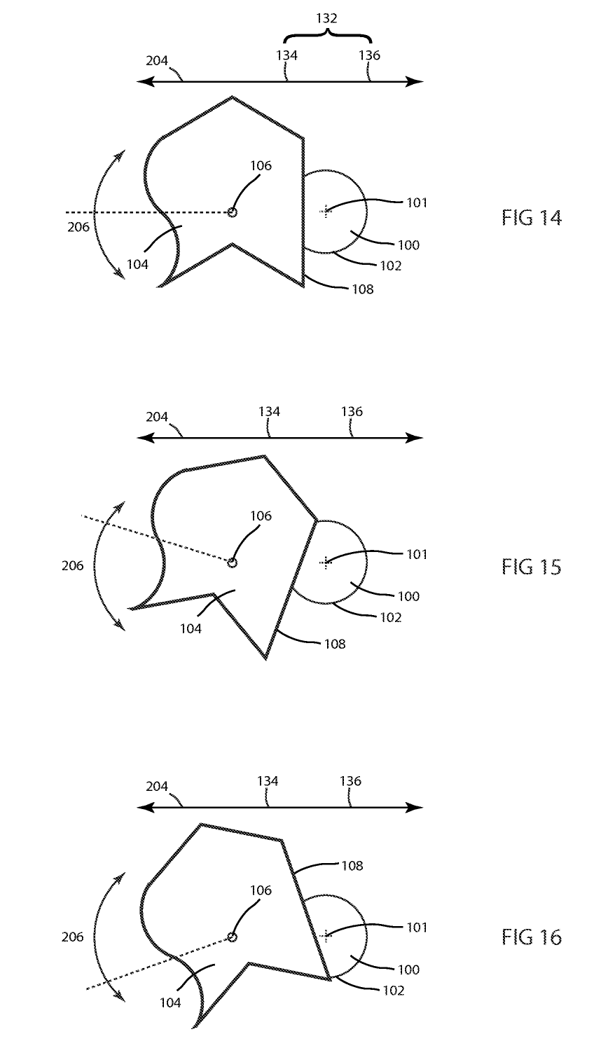

FIG. 14, FIG. 15 and FIG. 16 illustrates that the angular orientation of the leading edge may not be normal (90 degrees) relative to the linear degree of freedom illustrated by arrow 204.

Again though only one blade is illustrated, similar motion may apply for each of the other shutter blades of the framing shutter in an independent but similar manner. In FIG. 14, Blade 104 has central pivot point 106 and first edge 120 and has a second freedom of movement in the rotational direction indicated by arrow 206, rotating around central pivot point 106. In FIG. 6a blade 104 is positioned partially covering central aperture 102 with edge 120 vertical (normal or 90 degrees relative to the direction of the linear freedom of motion of the blade 104 illustrated by arrow 204). In FIG. 15 blade 104 has been rotated clockwise in the direction of arrow 206 such that edge 120 is now rotated from the vertical while blade 104 still partially covers central aperture 102 and thus partially occludes the light beam with rotated edge 120. In FIG. 16 blade 104 has been rotated counter clockwise in the direction of arrow such that edge 120 is now rotated from the vertical in the opposite direction. Blade 104 may further be freely rotated to any intermediate positions or to more extreme rotated positions. In any of these rotated positions blade 104 may continue to be moved towards or away from central aperture 102 as described in FIG. 5.

Note that in FIG. 14, FIG. 15 and FIG. 16 the range of motion and markers for the linear range of motion are not the same. This is also true for different angular orientations of the other leading edges of the shutter blade.

In addition to the selected edge, and the angular orientation of the edge relative to the linear direction of movement of the shutter blade, other factors may affect the range of effective motion of the individual shutter blades. For example, the linear and angular orientation and selection of leading edges of the other shutter blades can affect the range of motion across which linear movement of the shutter can be effective. The same is true of the range of motion of the angular position of the shutters leading edge. In the preferred embodiment these ranges of motion are calculated by the control system and may be used to make automatic corrections to either linear or angular position of each of the shutter blades depending on which ledge is selected for each shutter blade and what the linear and angular position is of the other shutter blades. In some embodiments these ranges of motion calculations are used to dynamically vary and set hard stops to the angular or linear motion of the shutter blades to prevent them from crashing into each other when the share a plane of motion.

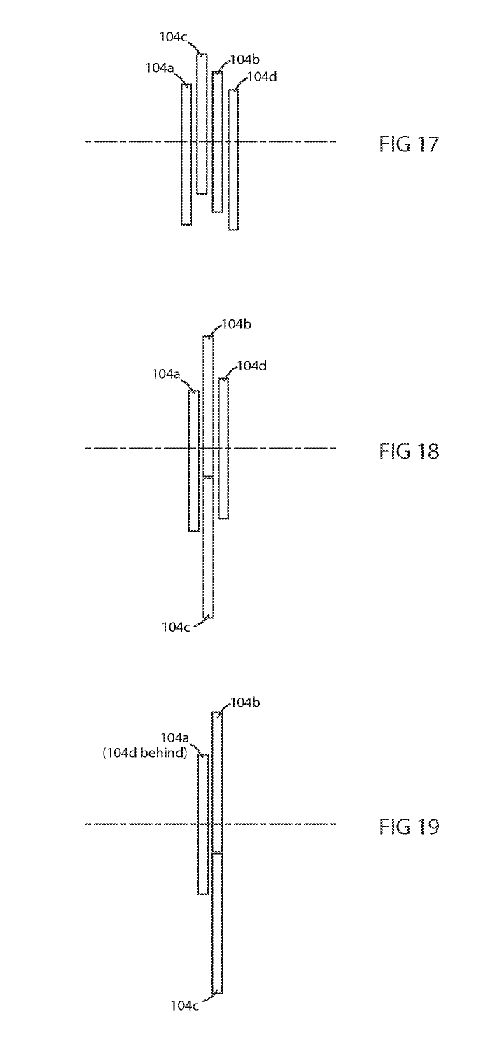

FIG. 17 illustrates a side view of a four shutter blade framing shutter system where each blade 104a, 104b, 104c and 104d operates in its own plane.

FIG. 18 illustrates a side view of a four shutter blade framing shutter system where two shutter blade 104a and 104d each operate in its own plane and two shutter blades 104b and 104c share an operational plane.

FIG. 19 illustrates a side view of a four shutter blade framing shutter system where two shutter blades 104a and 104d share an operational plane and two shutter blades 104b and 104c share another operational plane.

Although four edges 120, 130, 140 and 150 of blade 104 are herein illustrated the invention is not so limited and any number of edges with different shapes may be utilized on blade 104. The shapes of edges 120, 130, 140 and 150 of blade 104 are similarly not limited to the embodiment illustrated herein and in further embodiments the edges may take any shape desired for practical use or artistic effect.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

We claim:

1. An automated luminaire with a light beam framing shutter mechanism comprising:
a plurality of blades each with mechanism for linearly translating independently each blade in said plurality of blades into and out of the light beam;
rotating mechanism(s) independently rotating said blades relative to the light beam; and
a rotating mechanism(s) collectively rotating said blades about a central axis of the light beam.

2. The automated luminaire of claim 1 where a plurality of the blades each have multiple sides with geometrically different shaped edges.

3. The automated luminaire of claim 2 where each of the plurality of multi-side blades have a plurality of geometrical shaped edges that match a plurality of geometrical shaped edges the other blades in the plurality of multi-side blades.

4. The automated luminaire of claim 3 where one of the plurality of geometrical shapes of the edges is straight.

5. The automated luminaire of claim 3 where one of the plurality of geometrical shapes of the edges is a curved.

6. The automated luminaire of claim 3 where one of the plurality of geometrical shapes of the edges is protruded in its center.

7. The automated luminaire of claim 3 where one of the plurality of geometrical shapes of the edges is recessed in its center.

8. The automated luminaire of claim 1 where each blade operates in a different cross-sectional plane of a light beam axis of the automated luminaire.

9. The automated luminaire of claim 8 wherein each of the blades may overlap the other blades as they are linearly or rotationally translated relative to the light beam.

10. The automated luminaire of claim 1 where a plurality of the blades operate in the same cross-sectional plane of a light beam axis of the automated luminaire.

11. The automated luminaire of claim 10 where a translation and rotation of the blades that operate in the same cross-sectional plane are limited by a control system dependent on the translated position and rotational position of the other blades in the same plane so that the blades do not collide.

12. An automated luminaire with a light beam framing shutter mechanism comprising:
a plurality of blades each with mechanism for linearly translating independently each blade in said plurality of blades into and out of the light beam; and
rotating mechanism(s) independently rotating said blades relative to the light beam.

13. The automated luminaire of claim 12 where a plurality of the blades each have multiple sides with geometrically different shaped edges.

14. The automated luminaire of claim 12 where each of the plurality of multi-side blades have a plurality of geometrical shaped edges that match a plurality of geometrical shaped edges the other blades in the plurality of multi-side blades.

15. The automated luminaire of claim 14 where one of the plurality of geometrical shapes of the edges is straight.

16. The automated luminaire of claim 14 where one of the plurality of geometrical shapes of the edges is a curved.

17. The automated luminaire of claim 14 where one of the plurality of geometrical shapes of the edges is protruded in its center.

18. The automated luminaire of claim 14 where one of the plurality of geometrical shapes of the edges is recessed in its center.

19. The automated luminaire of claim 14 where each blade operates in a different cross-sectional plane of a light beam axis of the automated luminaire.

20. The automated luminaire of claim 19 wherein each of the blades may overlap the other blades as they are linearly or rotationally translated relative to the light beam.

21. The automated luminaire of claim 12 where a plurality of the blades operate in the same cross-sectional plane of a light beam axis of the automated luminaire.

22. The automated luminaire of claim 21 where a translation and rotation of the blades that operate in the same cross-sectional plane are limited by a control system dependent on the translated position and rotational position of the other blades in the same plane so that the blades do not collide.

23. The automated luminaire of claim 12 where a plurality of the blades operate in the same cross-sectional plane of a light beam axis of the automated luminaire.

24. The automated luminaire of claim 12 where in addition to independent translation and rotation of said blades the blades can be collectively rotated about a central axis of the light beam.
